(19) United States
(12) Patent Application Publication
(10) Pub. No.: US 2016/0094884 A1
(43) Pub. Date: Mar. 31, 2016

(54) METHOD AND APPARATUS FOR PROVIDING TRAILERS AND EFFECTS

(71) Applicant: THOMSON LICENSING, Issy de Moulineaux (FR)

(72) Inventor: Shaun Kohei WESTBROOK, West Hollywood, CA (US)

(21) Appl. No.: 14/868,004

(22) Filed: Sep. 28, 2015

Related U.S. Application Data
(60) Provisional application No. 62/058,024, filed on Sep. 30, 2014.

(51) Int. Cl. H04N 21/462; H04N 21/482; H04N 21/431; H04N 21/4722

(52) U.S. Cl. CPC H04N 21/4621; H04N 21/4722; H04N 21/482; H04N 21/431

(57) ABSTRACT

A trailer mode for a media service is provided. The trailer mode may provide trailers for content available on the media service platform (500, 540) to client devices (510) based on user preferences, viewing habits, and/or content themes. The trailer mode may be invoked on demand by a user and/or after a period of inactivity. The media service may use a combination of local and remote sources for playback of trailers during the trailer mode.

### FIELD OF INVENTION

The present disclosure generally relates to providing a screen saver mode of movie trailer snippets for media services, specially providing effects with the presentation of such trailer snippets.

### BACKGROUND

Media services are widely available for delivery of media content (movies, shows, documentaries, sports, news, etc.) to end users via television sets, computers, laptops, tablets, and mobile devices over a network connection. A user can search for titles or browse suggested titles available in different genres from within the user interface of the media service. The user interface is usually made up of a stationary background that may be a solid color (e.g., black) with interactive elements in the foreground that display the various pieces of media available for streaming.

To view a trailer or snippet of a particular piece of media, the user is required to select and enter a detailed view of the media of interest where a summary of the media may be available along with one or more trailers and/or snippets. This process may require several clicks and/or navigational commands to get into and out of areas of the media service where trailers and/or snippets of media can be viewed. Furthermore, users may find that viewing a trailer for a piece of media is unproductive when the media ends up being something the user is not interested in, but was drawn to due to creative cover art for the media or a poorly written synopsis that did not accurately convey the nature of the content. Furthermore, navigating through a network connected streaming service and viewing several trailers may consume bandwidth and affect Internet connectivity to others on the same network as well as consume valuable bandwidth required by the streaming service provider to transmit video content to client devices.

Therefore, there is a need to provide users easy access to view trailers, and more specifically, trailers of media content that the user may find interesting while making efficient use of bandwidth available to the media service provider and local network of the user.

### BRIEF SUMMARY

Some embodiments of the current disclosure provide a media service that receives an identification of locally stored trailers at a client device. The media service may transmit video trailers other than the stored trailers at full resolution to the client device during a first time period in response to the initiation of a trailer mode at the client. The media service may then transmit video trailers other than the stored trailers at reduced resolution to the client device during a second time period. Then the media service may transmit video trailers other than the stored trailers at low resolution to the client device during a third time period. The bandwidth utilized for each transmission may be less than the bandwidth required to transmit the trailers at a real time streaming rate.

Some embodiments may provide a client for the media service that transmits an identification of locally stored trailers at a client device to a media service. The media service client may receive video trailers at full resolution at the client device during a first time period in response to the initiation of a trailer mode. The client may store the full resolution trailers at the client device. The client may receive video trailers at reduced resolution at the client device during a second time period and store the reduced resolution trailers at the client device. The client may then receive video trailers at low resolution at the client device during a third time period store the reduced resolution trailers at the client device. The bandwidth utilized for receiving the video trailers may be less than the bandwidth required to receive the video trailers at a real time streaming rate.

In an exemplary disclosure, a method is disclosed where the operations of determining a first theme for a plurality of content, selecting an effect for the first theme, and the providing that effect to such content is disclosed.

In another exemplary disclosure, an apparatus of a processor and a memory with instructions is disclosed where the processor, when executing the instructions, determines a first theme for a plurality of content, select at least one effect corresponding to said first theme, and provide an output containing said plurality of content and said selected at least one effect.

The preceding Summary is intended to serve as a brief introduction to some embodiments of the present disclosure. It is not meant to be an introduction or overview of all inventive subject matter disclosed in this document. The Detailed Description that follows and the Drawings (or “Figures” or “FIGS.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the disclosure are set forth throughout this specification. However, for purpose of explanation, some embodiments are set forth in the following drawings.

FIG. 1 illustrates the use of scalable video over time for one embodiment of a trailer mode according to the present disclosure;

FIG. 2 illustrates a flow chart of an exemplary process used by some embodiments during the trailer mode;

FIG. 3 illustrates one embodiment for bandwidth reduction during a trailer mode;

FIG. 4 illustrates another embodiment of bandwidth reduction during a trailer mode;

FIG. 5 illustrates a block diagram of a media service system according to some embodiments of the present disclosure;

FIG. 6 illustrates a schematic block diagram of an exemplary computer system with which some embodiments may be implemented;

FIG. 7 illustrates one embodiment of a user interface during a trailer mode according to the present disclosure; and

FIG. 8 illustrates a flow chart of an exemplary process 800 used by some embodiments of the present disclosure to provide different effects that are to be played back with content/trailers.

### DETAILED DESCRIPTION

In the following detailed description, numerous details, examples, and embodiments are set forth and described. However, it will be clear and apparent to one skilled in the art that the disclosure is not limited to the embodiments set forth, and that the disclosed embodiments may be practiced without some of the specific details and examples discussed.

Media services may be implemented on a consumer device (e.g., television set, computers, laptops, tablets, mobile devices, and the like) to provide both media recommendations and playback of media that is streamed via a network or received over the air. For example, media services may include satellite, broadcast, cable, IPTV, streaming video or any other similar service that can transmit video over a network or over the air. Throughout this specification, a streaming media service may be referred to as the exemplary media service, however media services are not limited only to the described streaming media services.

The present disclosure provides the concept of grouping media into genres known as themes and delivering samples of media associated with particular themes via trailers and/or snippets of the media to the user. The creation of themes may include grouping particular titles together that share genres. For example, the movies “Matrix” and “Terminator” may be associated with a Science Fiction theme, “Love Story” and “The Notebook” may be associated with a Romance theme, and “The King's Speech” and “The Dam Busters” may be associated with History. Each title in a media service may be associated with one or more themes so a user indicating interest, directly or indirectly, in a particular theme can be presented with media trailers of recommended titles available on the media service.

The present disclosure further provides a screen saver mode or trailer mode that may be displayed in the foreground or background of the user interface. In some embodiments, The screen saver mode may be activated after a certain number of minutes of non-activity (e.g., nobody in a room determined by a one or more sensors (e.g., motion sensor, camera, gesture recognition device, etc.) and/or via non-use of a remote control, after which a series of trailers may be displayed by the media service. For example, after 5 minutes of non-activity, trailers comporting to the Science Fiction Theme may be shown on a rotating basis. In some embodiments the trailer mode may be initiated on demand if a user wishes to watch trailers recommended by the media service.

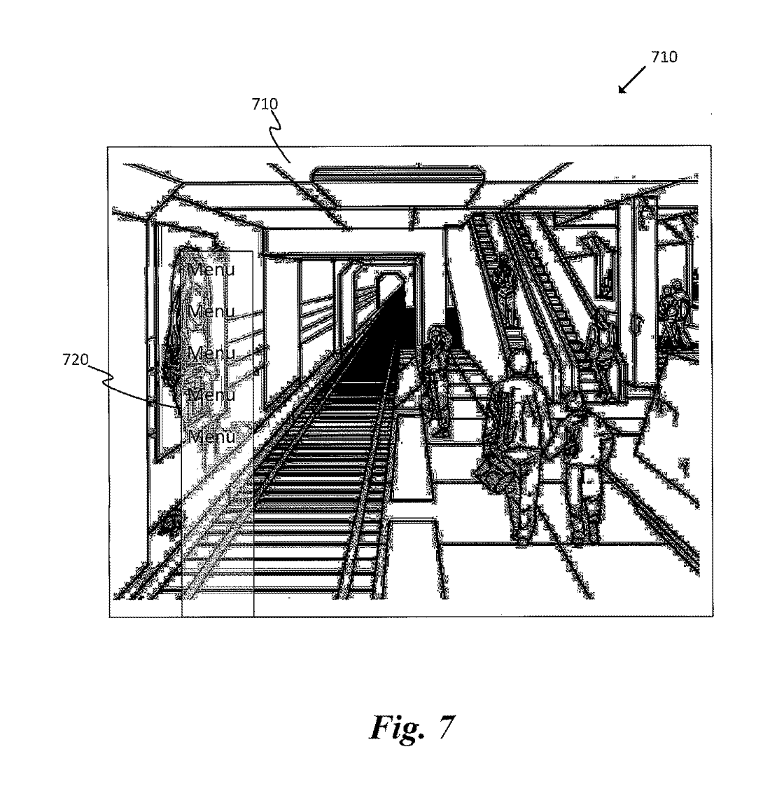

In some embodiments, the trailers may continuously play on a rotating basis in the background of some area of the user interface (e.g., a welcome page or top level menu interface) as illustrated in FIG. 7. Specifically, FIG. 7 shows a display 710 with a menu interface 720 in the foreground and a trailer 710 played in the background. In embodiments where the trailer mode provides trailers in the foreground, a user menu and/or interface may come into the foreground after user activity is detected (e.g., use of a remote control or similar peripheral).

The trailers may be full length trailers, extracted scenes (e.g. snippets) of a trailer, or snippets from the media content (e.g., scenes or moments from an episode of a television series). The trailers shown may comport to a “theme” as discussed above, and the theme of the trailers being displayed may be based on a pre-selection made by a user, based on system detected viewing habits, or based on the last viewed program, or other criteria derived from a combination of viewing habits and user preferences (e.g., a user may wish to view a mix of trailers from different themes during the trailer mode, select certain themes to always or never allow, only new release trailers, only trailers for content never viewed using the streaming service, etc.)

From the basis of the streaming media content, the video and audio from a server may be initially streamed to a consumer device, and in some embodiments the video quality of the stream may be degraded over time. For example, in embodiments where the screen saver mode is activated after detection of non-activity, streaming video trailers may be presented at a high quality level with a high bandwidth being used during the start of the screen saver mode to a first time point (T1). From a period after T1 to a second time period T2, the quality of the streaming video may be reduced where less bandwidth would be required to deliver the streaming media content. Further reductions in video quality with the associated use of bandwidth may take place until a minimum level of video is used to support the display of video trailers. If a user operates a control (indicating that a user is present to watch such trailers) and/or the streaming device or peripheral(s) (sensor, camera, etc.) recognizes that a user is present, full resolution playback of the trailer may be initiated or stayed.

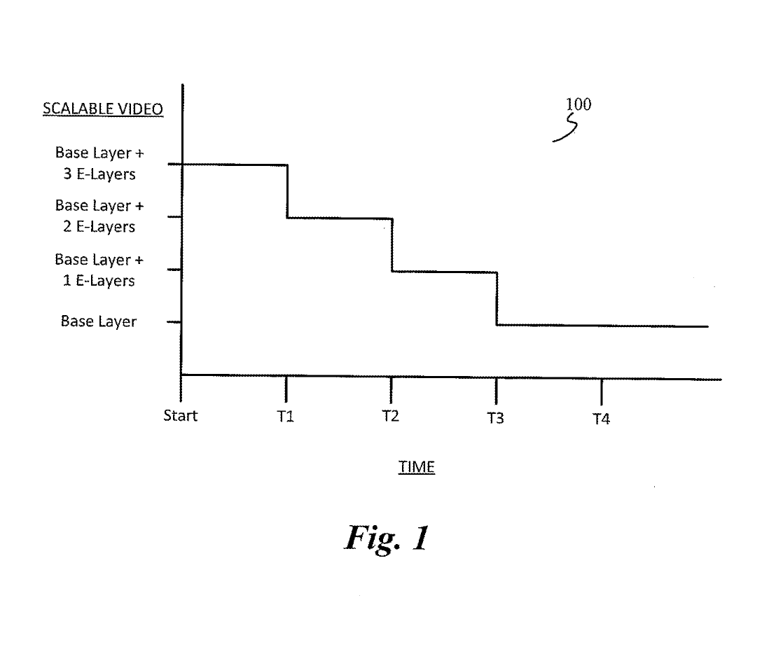

The preceding description illustrates the principles of the present disclosure. Further details, including examples of specific implementation will be provided in reference to FIG. 1-FIG. 6. It will be appreciated that those skilled in the art will be able to devise various arrangements that, although not explicitly described or shown in the subsequent Figures, embody the principles of the disclosure and are included within its scope.

In some embodiments of a trailer mode according to the present disclosure, low bandwidth streams of trailers may be scaled in quality, resolution, or both. Low resolution streams may employ scalable coding or may be implemented with one or more fully coded versions of a stream at a reduced quality, reduced resolution, or a combination of both. FIG. 1 illustrates the use of scalable video for a trailer mode over a period of time. In one embodiments of a trailer mode, a base layer and multiple enhancement layers (“E-Layers”) may be utilized between different time intervals, where the numbers of enhancement layers may be reduced as time goes on during the trailer mode resulting in a reduced resolution video stream to the user device. As illustrated, from a starting point of the trailer mode to time T1, a full resolution trailer may be displayed via a base layer and three enhancement layers. From time T1 to T2 the base layer and two enhancement layers may be provided, from time T2 to T3 the base layer and one enhancement layer may be provided, and from time T3 on only the base layer is provided. Accordingly, as one less enhancement layer is being transmitted, the corresponding use of bandwidth will also be reduced so that it may be allocated for other tasks on the network and reduce the burden of transmission for the media service. For example, from start to time T1, full bandwidth may be required for the trailer mode to stream to a user device, from time T1 to T2 three quarters of the full bandwidth may be utilized, from T2 to T3 half the required bandwidth may be utilized, and from T3 on one fourth of the required bandwidth may be utilized.

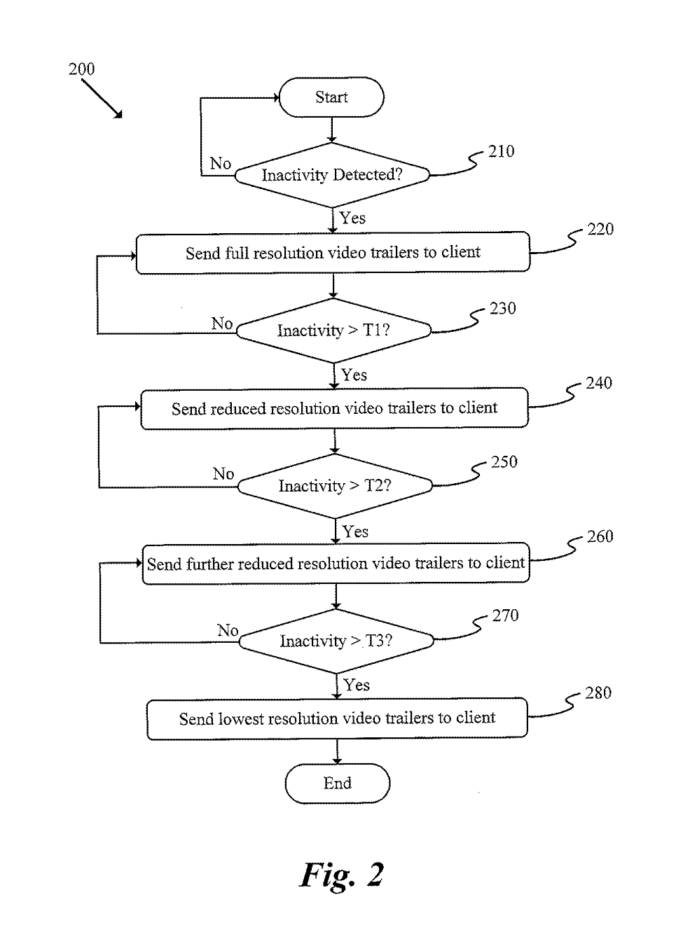

FIG. 2 illustrates a flow chart of an exemplary process 200 used by some embodiments of the present disclosure to provide reduced resolution trailers over a time of inactivity. The process 200 may begin by detecting (at 210) whether there has been any activity by the user within the streaming media service or if no user is present in the room. If inactivity is not detected, then there is no change to the interface currently being viewed on the streaming media service. If inactivity is detected, then the streaming media service may send (at 220) full resolution video trailers to the client device for display in the streaming media services interface.

Then the process 200 may check the period of inactivity and determine (at 230) whether the period of inactivity is greater than a predefined time, T1, which is measured from the time inactivity was first detected. If the time of inactivity is less than T1, then the streaming media service continues to send full resolution video trailers to the client. When the time of inactivity surpasses T1, the process 200 may begin to send (at 240) reduced resolution video trailers to the client. The reduced resolution video may, for example, be a base layer with one less enhancement layer compared to full resolution video as previously described.

Next, the process 200 may check the period of inactivity and determine (at 250) whether the period of inactivity is greater than a second predefined time, T2, which is also measured from the time inactivity was first detected. If the time of inactivity is less than T2, then the streaming media service continues to send reduced resolution video trailers to the client. When the time of inactivity surpasses T2, the process 200 may begin to send (at 260) further reduced resolution video trailers to the client. The further reduced resolution video may, for example, be a base layer with one less enhancement layer compared to reduced resolution video.

The process 200 may then check the period of inactivity and determine (at 270) whether the period of inactivity is greater than a third predefined time, T3, which is also measured from the time inactivity was first detected. If the time of inactivity is less than T3, then the streaming media service continues to send further reduced resolution video trailers to the client. When the time of inactivity surpasses T3, the process 200 may begin to send (at 280) the lowest resolution video trailers to the client. The lowest resolution video may, for example, be only a base layer stream of the video content. It will be appreciated by those skilled in the art that the number of pre-defined time periods may vary and the scale of reduced resolution video available may accordingly also vary so that more or less reduced resolution versions of trailers may be provided.

In some embodiments, the audio output may also be modified in response to switching to a reduced resolution video stream. For example, audio volume may be increased or decreased when the system determines that it will switch to a lower resolution video stream. The method for affecting audio volume may vary based on the implementation of the system in which the streaming media service is utilizing. In cases where the system includes the audio output amplifiers (and optionally the speakers), the control software may directly influence the amplitude of the audio output by adjusting the amplifier. In cases where the controller does not have the ability to directly influence the audio output amplitude, the controller may affect the audio amplitude by applying a gain to the audio stream in the digital domain before sending the decoded output to the output amplifier system.

For the cases in which the controller does not have the ability to affect the decoded audio (e.g., in a set top box “STB” sending compressed audio through HDMI, S/PDIF, IP or other interface which demands a compressed format), the controller may modify the audio amplitude prior to compressing the audio for output through such interfaces. Volume reduction may also be implemented by applying a gain to the audio samples prior to compressing the stream for output. Since the max output volume will be determined by the audio amplifier, which cannot be influenced by the controller, the controller will not be able affect the actual volume of the audio output. However, the controller may implement dynamic range compression prior to encoding for output, which will increase the end users perception of the audio volume.

Such modifications to the volume of the associated audio while displaying reduced quality video may be used to increase or decrease the attention of the user. For example, an increase in volume could be used to draw the user's attention back to the video, while a decrease in volume may be used to make the video playback less obtrusive during a ‘screen saver mode’.

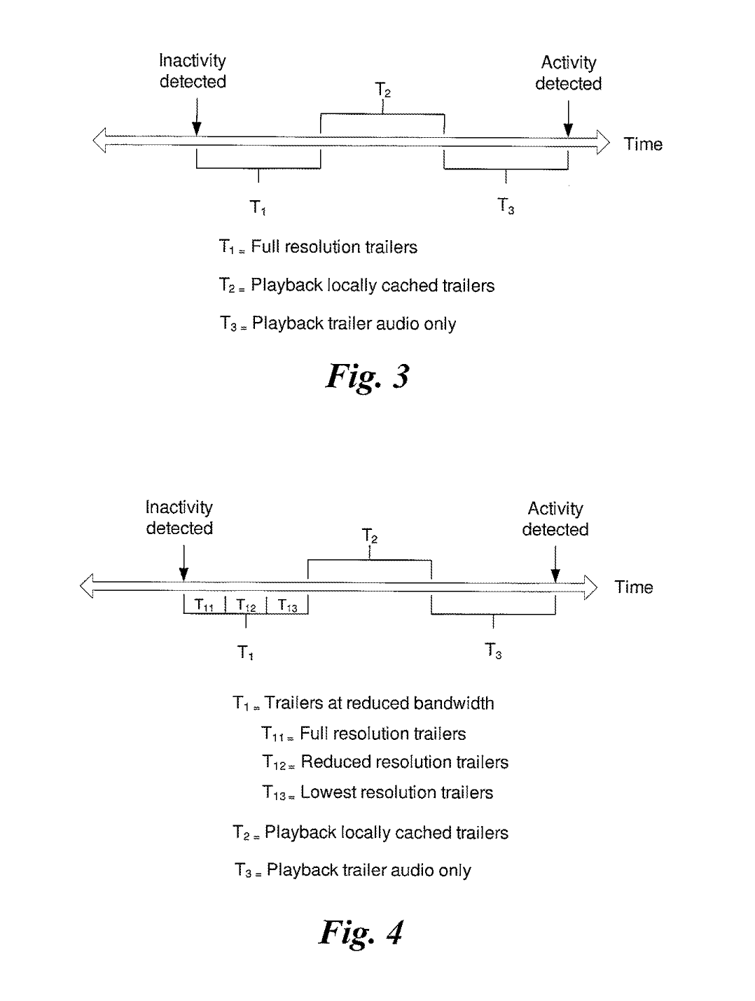

In another embodiment, the amount of bandwidth used during a trailer mode may be reduced over time by using local and remote sources of content. As illustrated in FIG. 3, when a period of inactivity is detected (e.g., via camera, motion sensor, gaming peripheral, non-use of remote, etc.), the system may begin showing full resolution trailers which are streamed to the client device during a first time period, T1. All trailers received during the first time period, T1, may be locally cached in volatile or non-volatile storage, as dictated by the constraints of the system. During the first time period, as trailers are locally cached, the trailers shown may be a combination of locally cached trailers and trailers received over the network which have yet to be locally cached. As trailers become locally cached, the system may repeat playback of one or more cached trailers allowing new trailers received during the first time period to arrive at a less than real-time rate.

The local system may also synchronize with the remote streaming media service system so the streaming media service is aware of which trailers are available in the local cache. The cached trailers may be marked with a valid time window, where the valid time window may be a function of time of day, day of the week, calendar date, etc., in order to prevent playback from cache of trailers which are not valid for the current time. In addition, the remote media service may use its knowledge about locally cached trailers to avoid sending trailers which are already cached locally and which are valid for the current time.

As illustrated in FIG. 3, After the first time period, T1, elapses the system may switch to show only the locally cached trailers for a second time period, T2. The local system may also synchronize with the remote streaming media service system so the streaming media service is aware of which trailers are available in the local cache. The trailers may be played repeatedly in the same order, may be played in arbitrary order (shuffle mode), or may be played in an order directed by the streaming server. As shown in FIG. 3, at the end of the second time period, the system may output only the audio portion of the trailers for a third time period, T3. The audio only playback may alternatively occur when it is detected that the screen has gone black or into an independent screen saver mode of the user device that is accessing the streaming media service. In some embodiments, the audio portion of trailers may be taken from locally cached trailers, streamed from a remote server, or some combination of both. The third time period may persist until terminated by detection of user activity or system entry into a power down or power standby mode.

FIG. 4 illustrates the combination of bandwidth reduction through reduced resolution video streaming coupled with locally caching trailers. As shown, during time T1, trailers may be streamed to the client a full resolution during T11, at reduced resolution at T12, and at the lowest resolution at T13. During T11, full resolution trailer may be locally cached which may allow for a less than real-time streaming rate for subsequent trailers. For example, when new trailers, which are not locally available to the user device, are provided from the streaming media service while a locally cached trailer is being displayed on the user device, bandwidth reduction may be achieved since real-time streaming of the new trailer may not be required. Specifically, when a new trailer is being transmitted to a client where the playback is occurring as the content is streamed in, a high bandwidth real-time streaming rates is required. However, when a new trailer is being transmitted to a client during the playback of a locally cached trailer, the new trailer does not require a real-time streaming rate and therefore reduction in bandwidth may be achieved.

At T12 in FIG. 4, the trailers being received at the client may be reduced resolution trailers. In some embodiments locally caching the reduced resolution trailers would also allow for a less than real-time streaming rate, further conserving bandwidth. Accordingly, when a new trailer is provided by the streaming media service during T12 that was not provided during T11, that particular trailer only has reduced resolution data available to be locally cached. One advantage for locally caching reduced resolution trailers is that the user device may only require one or more enhancement layers from the streaming media service rather than all video content when full resolution of the same trailer is required (e.g., if user activity is detected or replaying trailer during a full resolution trailer mode). Thus, less data needs to be transmitted from the streaming media service to the client for full resolution trailer to be viewed.

At T13 in FIG. 4, the trailers being received at the client may be the lowest resolution (e.g., base layer only). Similarly, some embodiments may locally cache the lowest resolution trailers to allow for a less than real-time streaming rate to similarly conserve bandwidth. The same effect of locally caching reduced resolution trailers as discussed previously would apply to locally caching the lowest resolution trailer so that less data is required to achieve full resolution of a repeated trailer at a later time.

At T2 in FIG. 4, playback of only locally cached trailers may occur so that no bandwidth is actively being utilized by the streaming media service and client device. At T3, some embodiments may enter an audio only playback mode. This may occur due to the client device entering its own screen saver mode or to conserve energy and reduce display usage.

In all the above examples, the trailer mode is initiated upon the detection of inactivity. However, in cases where a user initiates the trailer mode on demand, full resolution video trailers would be initially provided and continue if it is determined the user is present and/or engaged with the streaming media service. If inactivity is subsequently detected during a trailer mode initiated by the user, reduced resolution video and/or adjusted audio may be provided after a pre-determined amount of time. Accordingly, full resolution video would not be sent during a first time period of inactivity as provided in the previous examples. Instead, reduced resolution video would be provided during the first time period of inactivity because the user was already in a trailer mode and subsequently became disengaged with the streaming media service.

One of ordinary skill in the art will recognize that processes described in the preceding Figures may be performed in various appropriate ways without departing from the scope of the disclosure. For instance, the process may not be performed as one continuous series of operations in some embodiments. In addition, the process may be implemented using several sub-processes or as part of a larger macro-process. Furthermore, various processes may be performed concurrently, sequentially, or some combination of sequentially and concurrently. Moreover, the operations of the process may be performed in different orders.

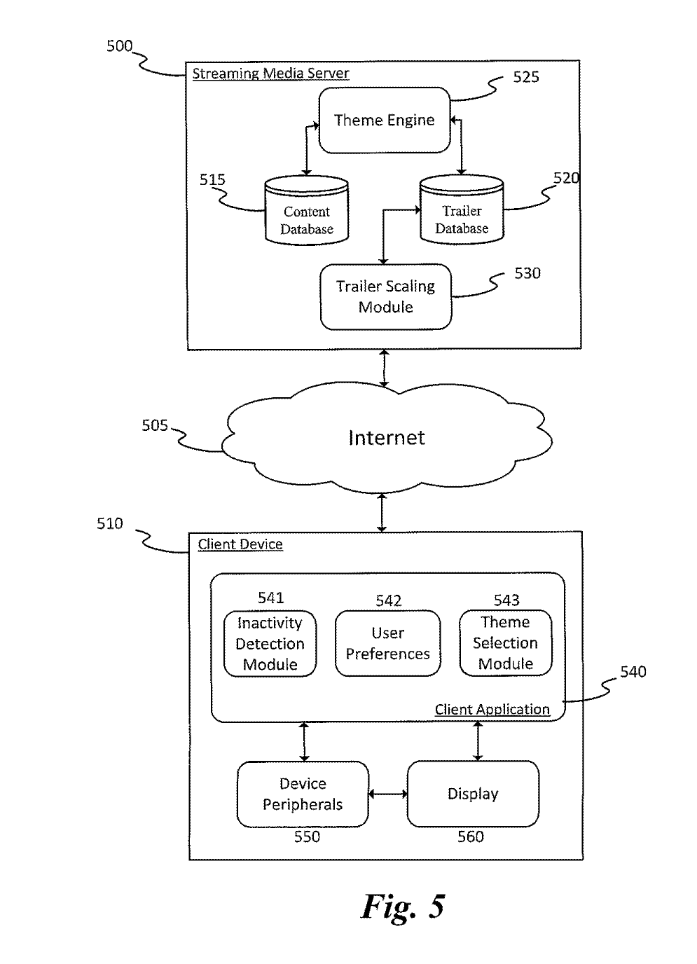

In some embodiments, the above-described operations may be implemented as software running on a particular machine such as a server or client device (e.g., desktop computer, laptop, or handheld device, television, game console, etc.) or as software stored in a computer readable medium. FIG. 5 illustrates an exemplary block diagram of a media service environment or platform for implementing a trailer mode according the present disclosure. One of ordinary skill in will recognize that the block diagram of FIG. 5 may only describe relevant aspects related to implementing a trailer mode in a media service environment and that other elements may be required to fully implement a media service platform.

As illustrated, the media service platform may include a streaming media server 500 that is connected to client devices 510 via the Internet 505. The streaming media server 500 may include a content database 515, a trailer database 520, a theme engine 525, and a trailer scaling module 530. Some embodiments may combine the streaming service content and trailers into one database or spread content and trailers over several databases. A theme engine 525 may be utilized to assign each piece of media content to one or more themes defined by the media service. The associated theme may be stored alongside each piece of content and/or their corresponding trailers so relevant trailers can be transmitted to client devices appropriately. The streaming media server may also include a trailer scaling module 530 that can adjust trailer resolution before transmission to the client based on the concepts discussed in FIG. 1-FIG. 4.

A client device 510 may be used to stream content from the streaming media servers 500 via the Internet 505 or other network. The client device may include a client application 540, device peripherals 550 (e.g., camera(s), motion sensor(s), remote(s), etc.), and a display 560. Some embodiments of the client device 510 may include a display integrated into the device (e.g., television, laptop, etc.) while others may use an external display (e.g., game console, PC, etc.). The same may apply to the various device peripherals which may be used to detect user inactivity.

The client device 510 may run the client application 540 which may be provided as a piece of software, hardware, or combination thereof by the streaming media service. The client application 540 may include an inactivity detection module 541, user preferences 542, and a theme selection module 543 among other modules that may be used to implement the media service on the client device 510.

The inactivity detection module 541 may communicate and receive inputs/commands from device peripherals 550 to ascertain whether the user is engaged in using the client application 540 of the media service. Should inactivity for a pre-defined time be determined, the inactivity detection module may trigger a trailer mode to commence. The trailer mode, as previously discussed, may play trailers in the background of a menu page and/or user interface, in a full screen foreground, or a combination of both. In an exemplary combination, trailers may play in the foreground until user activity is detected via a peripheral. When a user engages the client application, the trailers may continue to play in the background and menu options may appear in the foreground. In some embodiments, a user may also manually invoke the trailer mode to discover new content that the user may wish to view on the streaming media service

The selection of trailers to display in a trailer mode may be dependent on user preferences 542 and the theme selection module 543. User preferences 542 may allow a user to select or remove themes they wish to view trailers for, request a multi-theme based presentation of trailers, exclude trailers for watched movies, set length of trailers, set bandwidth limits, etc.

The theme selection module 543 may communicate with user preferences 542 as well as interpret historical viewing habits of the user to appropriately pick one or more themes when the trailer mode is invoked. Historical viewing habits may include all content viewed on the streaming media platform, last viewed programs, trends in viewing habits, and/or any combination thereof. The theme selection module 543, user preferences 542, and inactivity detection module 541 may all communicate with the streaming media server 500 to invoke the trailer mode of the present disclosure and deliver relevant trailers for display on the user device. In alternative embodiments, the theme selection module may reside at the streaming media server 500, and the streaming media server 500 may receive user preferences and combine that information with known viewing habits of the user to select one or more themes of trailers to send to a client device 510.

In some embodiments, the network may be a one-way broadcast network (e.g., satellite) or be comprised of a broadcast network and broadband network (e.g., Internet). In such instances, a set of common or popular trailers may be delivered via the broadcast path, while less popular or niche trailers may be delivered through the broadband path. This approach may free the broadband path from having to unicast a set of trailers which would like be sent to every subscriber. Accordingly, the broadband bandwidth may only be used to unicast trailers that are specific to the end user preference and/or profile.

It should be recognized by one of ordinary skill in the art that any or all of the components of client application 540 may be used in conjunction with the present disclosure. Moreover, one of ordinary skill in the art will appreciate that many other configurations may also be used in conjunction with the present disclosure or components of the present disclosure to achieve the same or similar results.

All examples and conditional language recited are intended for informational purposes to aid in understanding the principles of the disclosure and the concepts furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views embodying the principles of the disclosure. Similarly, it will be appreciated that any flow charts, diagrams, and the like represent various processes which may be substantially represented in computer readable media and so executed by a computer or processor, whether or not such computer or processor is explicitly shown.

One of ordinary skill in the art will recognize that the various sets of instructions defined by the disclosed processes are not exhaustive of the sets of instructions that could be defined and stored on a computer readable storage medium for implementing a streaming media service trailer mode of some embodiments of the present disclosure. In addition, the processes described are exemplary, and the actual implementations may vary. For example, different embodiments may define the various sets of instructions in a different order, may define several sets of instructions in one operation, may decompose the definition of a single set of instructions into multiple operations, etc. In addition, the disclosed processes may be implemented as several sub-processes or combined with other operations within a macro-process.

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

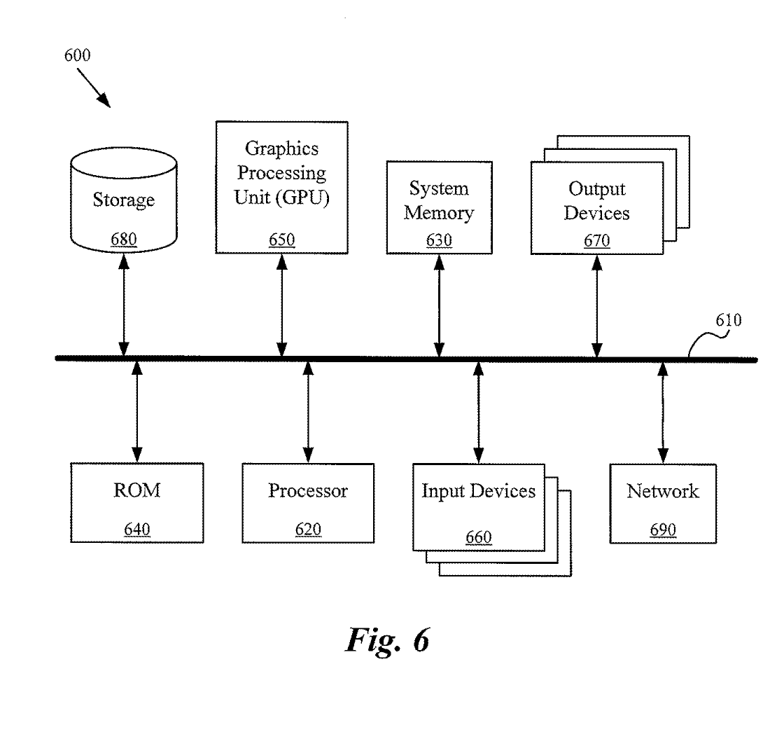

FIG. 6 illustrates a schematic block diagram of a computer system 600 with which some embodiments of the disclosure may be implemented. For example, the system described above in reference to FIG. 5 may be at least partially implemented using computer system 600 implemented on a streaming media server 500 or client device 510. As another example, the processes described in reference to FIG. 1-FIG. 4 may be at least partially implemented using sets of instructions that are executed using computer system 600.

Computer system 600 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 600 may include a bus 610, at least one processing element 620, a system memory 630, a read-only memory (“ROM”) 640, other components (e.g., a graphics processing unit) 650, input devices 660, output devices 670, permanent storage devices 680, and/or a network connection 690. The components of computer system 600 may be electronic devices that automatically perform operations based on digital and/or analog input signals.

Bus 610 may represent all communication pathways among the elements of computer system 600. Such pathways may include wired, wireless, optical, and/or other appropriate communication pathways. For example, input devices 660 and/or output devices 670 may be coupled to the system 600 using a wireless connection protocol or system. The processor 620 may, in order to execute the processes of some embodiments, retrieve instructions to execute and data to process from components such as system memory 630, ROM 640, and permanent storage device 680. Such instructions and data may be passed over bus 610.

ROM 640 may store static data and instructions that may be used by processor 620 and/or other elements of the computer system. Permanent storage device 680 may be a read-and-write memory device. This device may be a non-volatile memory unit that stores instructions and data even when computer system 600 is off or unpowered. Permanent storage device 680 may include a mass-storage device (such as a magnetic or optical disk and its corresponding disk drive).

Computer system 600 may use a removable storage device and/or a destination storage device as the permanent storage device. System memory 630 may be a volatile read-and-write memory, such as a random access memory (“RAM”). The system memory may store some of the instructions and data that the processor uses at runtime. The sets of instructions and/or data used to implement some embodiments may be stored in the system memory 630, the permanent storage device 680, and/or the read-only memory 640. For example, the various memory units may include instructions for authenticating a client-side application at the server-side application in accordance with some embodiments. Other components 650 may perform various other functions. These functions may include interfacing with various communication devices, systems, and/or protocols.

Input devices 660 may enable a user to communicate information to the computer system and/or manipulate various operations of the system. The input devices may include keyboards, cursor control devices, audio input devices and/or video input devices. Output devices 670 may include printers, displays, and/or audio devices. Some or all of the input and/or output devices may be wirelessly or optically connected to the computer system.

Finally, as shown in FIG. 6, computer system 600 may be coupled to a network through a network adapter 690. For example, computer system 600 may be coupled to a web server on the Internet such that a web browser executing on computer system 600 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with the disclosed embodiments. Moreover, one of ordinary skill in the art will appreciate that many other system configurations may also be used in conjunction with the disclosed embodiments or components of the embodiments.

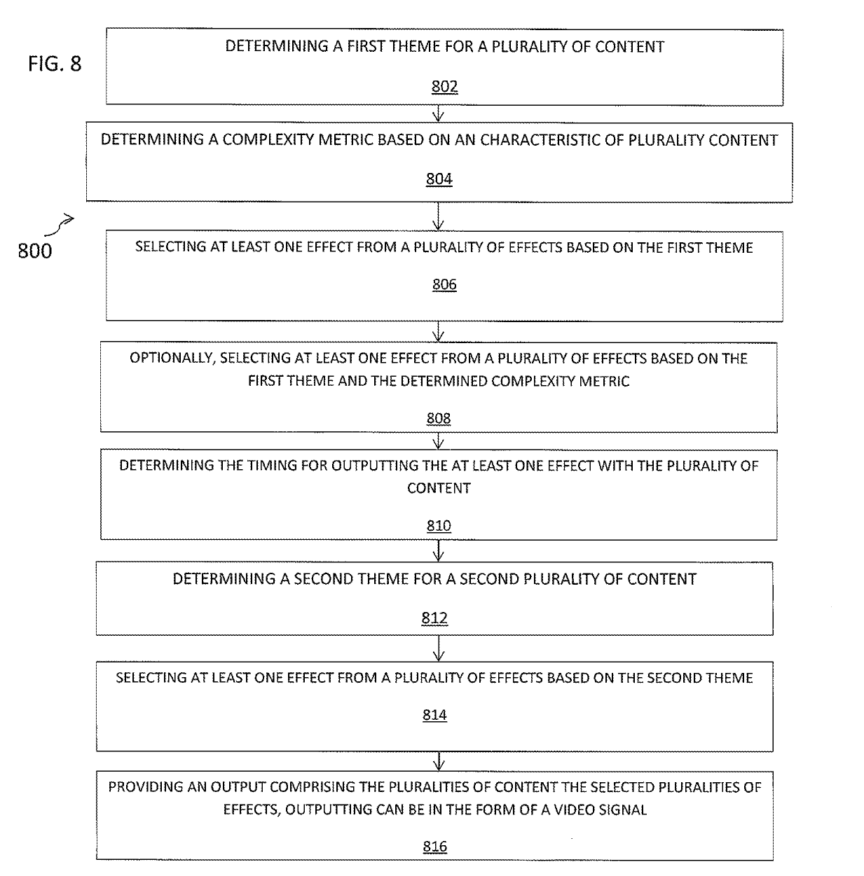

FIG. 8 illustrates a flow chart of an exemplary process 800 used by some embodiments of the present disclosure to provide different effects that are to be played back with content/trailers. In an exemplary embodiment, the trailers can be played back with effects such as animations, video swipes, sound effects, video graphics, and the like which are combined with the presentation of presented trailers. Specifically, the effects that are used are associated with a particular theme of the trailers that are played back. Various themes can relate to the genre of the trailers that are presented where various themes include action, sports, adventure, honor, romance, comedy, crime, western, fantasy, historical, mystery, political, documentary, historical fiction, satire, science fiction, thriller, animation, and the like.

The timing of when effects are presented can also be varied. For example, effects can be presented before the content is presented, after content is presented, while said content is being presented, and in between such content. That is for an exemplary embodiment, a first trailer can be shown, a first effect is played, and then a second trailer is played. In another exemplary embodiment, a first effect is played with a first trailer and a second effect is played with a second trailer. Different variations of effects and the playback of such effects include an animation, a sound effect, a visual effect, a fade effect, a wipe effect, a graphic that is overlaid over said at least one content, a graphic that is rendered on top of said at least one content, a graphic that is rendered to the side of said at least one content, a graphic that is rendered at the bottom of said at least one content, an animation that is overlaid over said at least one content, an animation that is rendered at the top of said at least one content, an animation that is rendered to the side of said at least one content, an animation that is rendered at the bottom of said at least one content, and the like.

The presented principles will then have certain effects assigned to different types of themes. For example, with an adventure theme certain animations of people running across a screen being followed by monsters, sound clips of gunshots, graphics of famous adventure actors, and the like can be rendered during or between the presentation of adventure themed trailers. In another illustrative example, for a romance theme animations of hearts floating across a screen, clips of kissing, graphics of famous scenes of actors kissing, and the like can be rendered during or in between the presentation of romance themed content. Other themes and types of effects can be presented in accordance with the presented principles.

Referring back to flowchart 800, step 802 presents a step of identifying a theme that is associated with trailers or other content that are to be presented. The theme can be determined by processor 620 referring to FIG. 6 from information that is part of the trailers, metadata embedded within content, metadata appended to said content, using keywords associated with content to queried in a database to determine a theme, recognizing watermarks embedded in content, and the like. Other approaches for determining a theme can be used in accordance with the exemplary principles.

In step 804, processor 620 can be used to determine a complexity metric for the plurality of content that is to be outputted. The complexity metric can be related to how much processing power will be necessary to output/playback content. For example, complex content that contains a lot of scene changes, that is a higher resolution, that is an encoded in a very data intensive format, and the like can cause elements such as processor 620 and GPU 650 to have difficulty generating/outputting such content. This problem can be further hampered when applying an effect to such content.

The complexity factor determination of 804 helps an apparatus determine what effects should be outputted. For example, a static graphic can be used when content is determined to have a high complexity factor. Likewise, a very graphic intensive animation can be used if the content is determined to have a very simple complex can be used as well. Different complexity metrics which can be used by analyzing content include number of scene changes for a content, a bit rate for a content, color gamut for, video resolution for content, audio format for content, video format for content, and the like.

In step 806, an effect is selected from a plurality of effects where the effects selected are based on theme of the content to be outputted/played back. Themes and the related effects for such themes were explained previously in this specification. Other themes and effects can be used in accordance with the described principles. In an optional step 808, the effect selected can be selected in view of both the theme of content to be outputted/played back and the complexity metric determined in step 804.

In step 810, the timing for when to apply selected effects for content is determined. The timing of when to apply an effect can be during the same time content is outputted, in between the outputting of each content from a plurality of content, before content is outputted, after said content is outputted, and the like. Such a timing operation can be determined by processor 620, GPU 650, and/or a combination thereof, and the like.

Step 812 has a second theme being determined for a second plurality of trailers/content and associated effects will be selected for the second plurality of content in step 814. Content is then provided to be outputted with the associated selected effects with the timing of when to apply such effects in step 816. The providing an output of step 816 can be the generation of information that is transferred to a processor to create a video and/or audio signal, used by a processor to have such information stored in a storage device/memory, and the like. In an embodiment of the exemplary principles, the information is presented in the form of a video signal although other formats can be used. Note, content/trailer can come from sources such a local cache, a local storage device, broadcast source, said plurality of content is streamed from a remote source, a satellite source, a cable source, and the like.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the disclosure has been described with reference to numerous specific details, one of ordinary skill in the art will recognize that the disclosure can be embodied in other specific forms without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

What is claimed is:

1. A method comprising:
determining a first theme for a plurality of content;
selecting at least one effect corresponding to said first theme;
providing an output containing said plurality of content and said selected at least one effect.

2. The method of claim 1 wherein said plurality of content is a plurality of trailers.

3. The method of claim 1 wherein said providing an output step is the generating of a video signal.

4. The method of claim 1 additionally comprising determining a complexity metric for said plurality of content where said selection step uses said complexity metric and said first theme to select said at least one effect.

5. The method of claim 4 wherein said complexity metric is at least one element selected from the group comprising: number of scene changes for a content selected from said plurality of content, a bit rate for a content selected from said plurality of content, color gamut for content selected from said plurality of content, video resolution for content selected from said plurality of content, audio format for content selected from said plurality of content, and video format for content selected from said plurality of content.

6. The method of claim 1 wherein a timing of the outputting of said at least effect is at least one element selected from the group comprising: during the same time said plurality of content is outputted, in between the outputting of each content of said plurality of content, before said plurality of content is outputted, after said plurality of content is outputted.

7. The method of claim 1 where said at least one effect is at least one element selected from the group comprising: an animation, a sound effect, a visual effect, a fade effect, a wipe effect, a graphic that is overlaid over said at least one content, a graphic that is rendered on top of said at least one content, a graphic that is rendered to the side of said at least one content, a graphic that is rendered at the bottom of said at least one content, an animation that is overlaid over said at least one content, an animation that is rendered at the top of said at least one content, an animation that is rendered to the side of said at least one content, and an animation that is rendered at the bottom of said at least one content.

8. The method of claim 1 additionally comprising:
determining a second theme for a second plurality of content, wherein said second theme is different than said first theme;
selecting a second least one effect corresponding to said second theme;
providing an output containing said second plurality of content and said second selected least one effect.

9. The method of claim 1 wherein said theme is at least one element selected from the group comprising: action, sports, adventure, honor, romance, comedy, crime, western, fantasy, historical, mystery, political, documentary, historical fiction, satire, science fiction, thriller, and animation.

10. The method of claim 1 wherein said plurality of content is received from at least one element selected from the group comprising: a local cache, a local storage device, broadcast source, said plurality of content is streamed from a remote source, a satellite source, and a cable source.

11. A apparatus comprising:
a processor; and
a memory, storing instructions that, when executed, cause the apparatus to
determine a first theme for a plurality of content, select at least one effect corresponding to said first theme, and provide an output containing said plurality of content and said selected at least one effect.

12. The apparatus of claim 11 wherein said plurality of content is a plurality of trailers.

13. The apparatus of claim 11 wherein said providing operation is the generating of a video signal.

14. The apparatus of claim 11 wherein said stored instructions further comprises, determining a complexity metric for said plurality of content and said selection operation uses said complexity metric and said theme to select said at least one effect.

15. The apparatus of claim 14 wherein said complexity metric is at least one element selected from the group comprising: number of scene changes for a content selected from said plurality of content, a bit rate for a content selected from said plurality of content, color gamut for content selected from said plurality of content, video resolution for content selected from said plurality of content, audio format for content selected from said plurality of content, and video format for content selected from said plurality of content.

16. The apparatus of claim 11 wherein a timing of the outputting of said at least effect is at least one element selected from the group comprising: during the same time said plurality of content is outputted, in between the outputting of each content of said plurality of content, before said plurality of content is outputted, after said plurality of content is outputted.

17. The apparatus of claim 11 wherein said at least one effect is at least one element selected from the group comprising: an animation, a sound effect, a visual effect, a fade effect, a wipe effect, a graphic that is overlaid over said at least one content, a graphic that is rendered on top of said at least one content, a graphic that is rendered to the side of said at least one content, a graphic that is rendered at the bottom of said at least one content, an animation that is overlaid over said at least one content, an animation that is rendered at the top of said at least one content, an animation that is rendered to the side of said at least one content, and an animation that is rendered at the bottom of said at least one content.

18. The apparatus of claim 11 additionally comprising stored instructions, when executed by said processor cause said apparatus to:
determine a second theme for a second plurality of content wherein said first them and said second theme are different, select at second least one effect corresponding to said second theme, provide an output containing said second plurality of content and said second selected least one effect.

19. The apparatus of claim 11 where said first theme is at least one element selected from the group comprising: action, sports, adventure, honor, romance, comedy, crime, western, fantasy, historical, mystery, political, documentary, historical fiction, satire, science fiction, thriller, and animation.

20. The apparatus of claim 11 wherein said plurality of content is received from at least one element selected from the group comprising: a local cache, a local storage device, broadcast source, said plurality of content is streamed from a remote source, a satellite source, and a cable source.
